(19) United States
(12) Patent Application Publication
(10) Pub. No.: US 2024/0225149 A1
(43) Pub. Date: Jul. 11, 2024

(54) CLIP-ON MASK FRAME

(71) Applicant: Takeuchi TSUNEO, Saitama (JP)

(72) Inventor: Takeuchi TSUNEO, Saitama (JP)

(21) Appl. No.: 18/286,216

(22) PCT Filed: Apr. 6, 2022
(86) PCT No.: PCT/JP2022/017130

§ 371 Date: Oct. 9, 2023

(30) Foreign Application Priority Data
Apr. 8, 2021 (JP) 2021-066129

(51) Int. Cl. A41D 13/11

(52) U.S. Cl. CPC A41D 13/1161; A41D 13/1192

(57) ABSTRACT

The clip-on mask frame according to the present invention creates a space between the mask and the face by attaching it to the mask, making it easier to breathe. A space can be created between the mask and the face so that it is easy to wear, does not press the face, and the position can be easily adjusted after wearing by grasping a handle protruding from below the chin. The position can be adjusted without touching the mask and allowing the mask to be placed on a flat surface such as a desk by attaching arms to the mask when the mask is temporarily taken off.

### TECHNICAL FIELD

Provided is a mask frame of a type that, when attached to a mask (1), creates a space between the mask (1) and a face (2) to facilitate breathing. By using the mask frame, a space created between the mask (1) and the face (2) is larger than in a conventional mask frame and the like. Further, the mask frame can be easily attached to the mask (1), does not put pressure on the face (2) and thus, leaves no marks on the face (2), and a position of the mask frame can be easily adjusted in a worn state. When the mask (1) is temporarily removed, the mask (1) can be placed on an object having a flat surface such as a desk or can be hung from the neck by a neck strap (14), so that the mask (1) does not contact other objects for sanitary purposes.

### BACKGROUND ART

When using the mask (1), the mask (1) may stick to the face (2) when a user breathes in, making it difficult to breathe. In particular, the mask (1) is more likely to stick to the face (2) when a user breathes faster and heavily, such as after doing exercise. Therefore, it is necessary to create a space of a certain size between the mask (1) and the face (2) and to maintain that space. To achieve this, there are many products on the market that can be worn between the mask (1) and the face (2) to create a space. These are called mask frames, mask assisting tools, mask brackets, mask spacers, and the like (hereinafter abbreviated as mask frames and the like) and are widely used in environments where people are required to wear masks (1).

### CITATION LIST

### Patent Document

Patent Document 1: Japanese Utility Model 3231124

### Non-Patent Document

Non-Patent Document 1: JECOL Co., Ltd., Mask Spacer MS-2PC, Mask Spacer MS-2PC, [online], Aug. 1, 2020, [accessed on Apr. 8, 2021], Internet <URL: https://jecol.co.jp/allproduct/etc_goods/mask_spacer>

### SUMMARY OF INVENTION

### Technical Problem

FIG. 1 illustrates a cross-sectional view of an upper lip area of a state of a face (2) when a user wears a mask (1), a mask frame, and the like, viewed from above. FIG. 1 illustrates, from the top, a mask frame (4) of Patent Document 1, a mask frame (5) of Non-Patent Document 1, and a mask frame (6) of a clip mask frame of the invention of the present application.

Patent Document 1 describes a general mask frame and the like that is used by being sandwiched between the mask (1) and the face (2). When being worn, the mask frame is in the state illustrated in the topmost diagram of FIG. 1. The mask frame is sandwiched between the mask (1) and the face (2) to be used. The mask frame (5) is pressed against the face (2) by the force of ear straps (3), and thus, a mark is likely to appear on the face (2) when the mask frame (5) is used for a long time. This represents a first problem. In order to adjust the position of the mask frame (5) in a worn state, the mask (1) needs to be touched, which is unsanitary. This represents a second problem. When the mask (1), the mask frame, and the like are temporarily removed during eating and the like, the mask (1) and the mask frame (5) contact a desk and the like, which is unsanitary, so that it is difficult to find a place to store the mask (1) and the mask frame (5). This represents a third problem.

Non-Patent Document 1 describes a mask frame and the like that is fixed to the ear straps (3) of the mask (1) and integrally formed with the mask (1). When being worn, the mask frame is in the state illustrated in the middle diagram of FIG. 1. This configuration utilizes the warping force of the mask (1) when being worn to secure a space within the mask (1). Unlike Patent Document 1 mentioned above, the mask frame (6) is not sandwiched in the space between the mask (1), but is integrally formed with the mask (1), and the mask frame (6) is not pushed against the face (2) by the force of the ear straps (3). Therefore, no mark is left on the face (2) and the first problem is solved. However, the second problem and the third problem are still unsolved. Further, when wearing the mask (1), a space can be secured in a space (7) in the front direction of the face (2) where the greatest warping force is applied. However, a space created in a lateral portion (8) from the front of the face (2) to the cheeks is small. This represents a fourth problem.

### Solution to Problem

When the clip mask frame of the invention of the present application is worn as illustrated in FIG. 2, the clip mask frame only contacts the chin portion of the face (2), so that there is no feeling of pressure to the face (2) and no wearing mark appears on the face (2), and thus, the first problem is solved. If a handle (12) is attached to the clip mask frame of the invention of the present application, as illustrated in FIG. 4, the handle (12) can protrude from below the chin when the clip mask frame is worn. Thus, by grasping the handle (12) protruding from below the chin, the position can be adjusted without touching the mask (1), so that the second problem is solved. Further, if the handle (12) and arms (13) are attached as illustrated in FIG. 6, the arms (13) and the handle (12) at a lower portion of the mask (1) form a pedestal when the mask (1) is temporarily removed, so that the mask (1) can be placed on a flat surface, such as illustrated in FIG. 8. As illustrated in FIG. 9, when a neck strap (14) is attached to the arms (13), and the mask (1) is removed and hangs from a neck, the handle (12) and the arms (13) form a pedestal, and thus, the mask (1) can be prevented from contacting the clothing. Therefore, the mask (1) can be placed in various locations and the third problem is solved. The clip mask frame of the invention of the present application is attached to the lower part of the chin by utilizing the fact that the lower part of the mask (1) wraps around under the chin when the mask (1) is worn. As illustrated in FIG. 1, a tension component (10) extends not only in the space (7) in the front direction of the face (2) from the lower portion of the chin, but also in the lateral portion (8) from the front portion of the face (2) to each of the cheeks, and the mask (1) is pushed from the inside to secure the space in this portion, so that a larger space can be secured than by a conventional mask frame or the like. Thus, the fourth problem is solved.

### BRIEF DESCRIPTION OF DRAWINGS

FIG. 1 illustrates a cross-sectional view of an upper lip area of a state of a face (2) when a user wears a mask (1), a mask frame, and the like, viewed from above. FIG. 1 illustrates, from the top, a mask frame (4) of Patent Document 1, a mask frame (5) of Non-Patent Document 1, and a clip mask frame (6) of the invention of the present application.

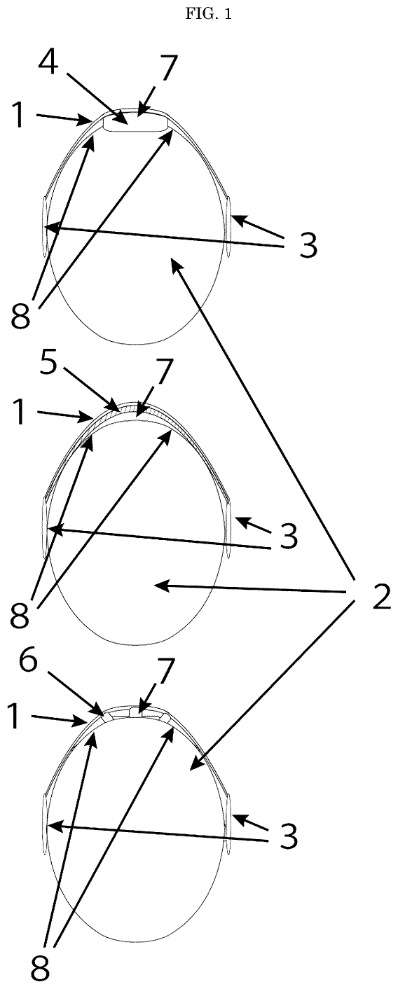

FIG. 2 illustrates diagrams of a structure and a worn state of the clip mask frame of the invention of the present application.

FIG. 3 illustrates a prototype of the clip mask frame of the invention of the present application.

FIG. 4 illustrates diagrams of a structure and a worn state of the clip mask frame of the invention of the present application to which a handle (12) is attached.

FIG. 5 illustrates a prototype of the clip mask frame of the invention of the present application to which the handle (12) is attached.

FIG. 6 illustrates diagrams of a structure and a worn state of the clip mask frame of the invention of the present application to which arms (13) are attached.

FIG. 7 illustrates a prototype of the clip mask frame of the invention of the present application to which the arms (13) are attached.

FIG. 8 illustrates a state in which the prototype of the clip mask frame of the invention of the present application stands on a flat surface.

FIG. 9 illustrates a prototype of the clip mask frame of the invention of the present application to which a neck strap (14) is attached.

FIG. 10 illustrates a state in which tension components (10) of the clip mask frame of the invention of the present application are not rod-shaped, but of a frame type.

FIG. 11 illustrates a state in which only one tension component (10) is provided on a front surface of the clip mask frame of the invention of the present application.

FIG. 12 illustrates a state in which two of the tension components (10) of the clip mask frame of the invention of the present application extend in a lateral direction from the front surface of the face (2).

FIG. 13 illustrates examples of a notch (15) of the arm (13).

FIG. 14 illustrates an integral configuration in which a commercially available assisting tool (16) of the mask (1) for preventing glasses from fogging and the clip mask frame of the invention of the present application are simultaneously worn.

FIG. 15 illustrates a diagram of a state in which the tension components (10) are inserted into the mask (1) and slightly bent.

### EMBODIMENTS

In a clip mask frame of the invention of the present application, a tension component (10) stretches inside a mask (1) from a chin portion of the mask (1). Therefore, even if the mask (1) is worn for a long time, the mask (1) does not leave a mark on a face (2). The tension component (10) stretches inside the mask (1) from the chin portion, so that sufficient space can be secured not only on a front surface of the face (2), but also in a slanted lateral direction.

A main feature of the clip mask frame of the invention of the present application compared to other mask frames is that, when the mask (1) is removed, the mask (1) can be placed on a table or the like in the same state as when the mask (1) is worn. At this time, the mask (1) does not touch the table or the like. In this standing state, the mask (1) is easily seen, which prevents accidental contact. If the mask (1) is stored in a mask case or the like, the humidity on the surface of the mask (1) increases and bacterial growth accelerates. By maintaining the mask (1) in a standing state, the mask (1) can dry and it is possible to prevent bacterial growth. Further, in this state, a disinfectant spray or the like can be easily sprayed onto both sides of the mask (1).

Another feature of the clip mask frame of the invention of the present application is that the clip mask frame can also be used by attaching a neck strap (14) to the mask (1). Originally, the neck strap (14) is not attached to the mask (1). This is because, when the mask (1) hangs from a neck, the mask (1) sticks to clothing, which is unsanitary. However, by employing the invention of the present application, the mask (1) does not stick to the clothing when the mask (1) hangs from the neck, which is useful in cases such as smoking a cigarette or drinking juice while standing. Further, as mentioned in the example before, the mask (1) can be dried and easily sprayed with a disinfectant spray or the like.

Further, no large force is applied to any locations of the clip mask frame of the invention of the present application, so that the clip mask frame can be manufactured and used as a disposable item. In this case, a main body (9), the tension component (10), a handle (12), and arms (13) may be formed of paper such as thick paper, and the portion of a clip (11) can be formed of a sticker or an adhesive.

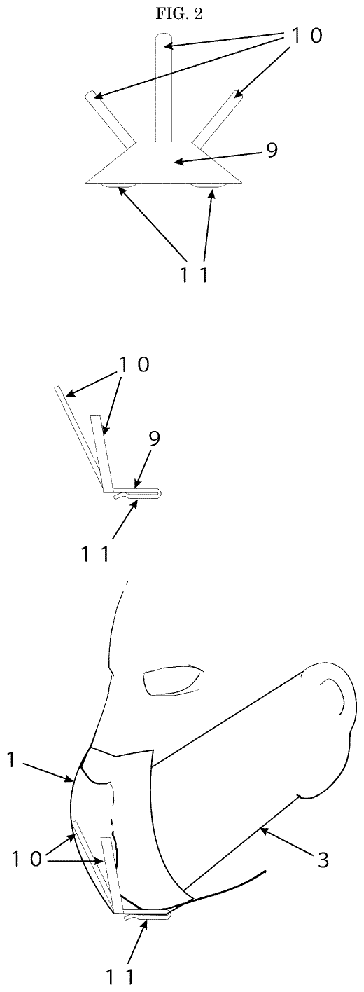

As illustrated in FIG. 2, the structure of the clip mask frame of the invention of the present application includes the main body (9) that is attached to a lower part of the mask (1) and serves as a portion on which a chin rests, the tension component (10) that pushes the mask (1) from inside to secure a space inside the mask (1), and a clip (11) for attaching the clip mask frame of the invention of the present application to the mask (1).

The main body (9) is shaped as a thin plate, and the tension component (10), the clip (11), and the like are attached to the main body (9). The main body (9) is attached to a lower part of the mask (1) with the clip (11) and is integrally formed with the mask (1). The main body (9) is positioned under the chin when the mask (1) is being used, and serves as a component supporting the tension component (10) from below. The material of the main body (9) is preferably a resin such as polypropylene, which is light and flexible and is not easily affected by sweat or moisture. When manufacturing and using the invention of the present application as a disposable item, the material may be paper such as thick paper. An upper surface of the main body (9) where the chin rests is preferably made of a material that can be adjusted to the shape of the chin, such as a sponge material, so that the chin and the main body (9) are attached to each other and no further gap is created when the main body (9) is worn. This portion directly contacts the skin, and thus, a material that is soft and comfortable to wear may be used. Further, the main body (9) is integrally formed with the mask (1), so that the main body (9) is preferably light in weight, and thus, the main body (9) may be shaped like a lattice or a portion thereof may be cut out.

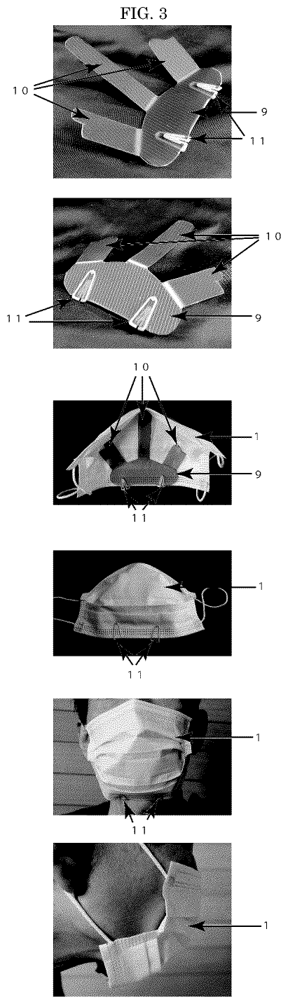

The clip (11) is used to attach the lower part of the mask (1) and the main body (9), so that the mask (1) and the main body (9) are integrally formed. The clip (11) may be integrally formed with the main body (9), but does not necessarily have to be integrally formed with the main body (9), as illustrated in the picture of the prototype in FIG. 3, and a commercially available clip (11) may be used to wear the mask (1) and the main body (9) together. The clip (11) is integrally formed with the mask (1), and thus, it is preferable to use a material that is as thin and light as possible. However, the clip (11) may also include a spring. Further, instead of the clip (11), the main body (9) may be fastened to the mask (1) by utilizing a hook-like object, a hairpin, a sticker, double-sided tape, an adhesive, or the like. Any fixing method may be used, as long as the main body (9) can be stably fastened to the lower part of the mask (1). It is preferable to use a method by which the main body (9) can be stably held, even when wearing the mask (1) formed of a thick material or a plurality of the masks (1). Any material may be used, but it is preferable that the material is as thin and light as possible, and is not easily affected by sweat or moisture.

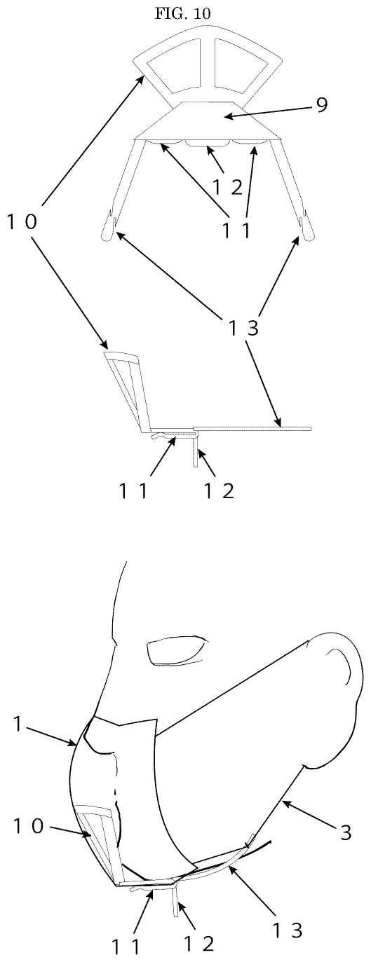

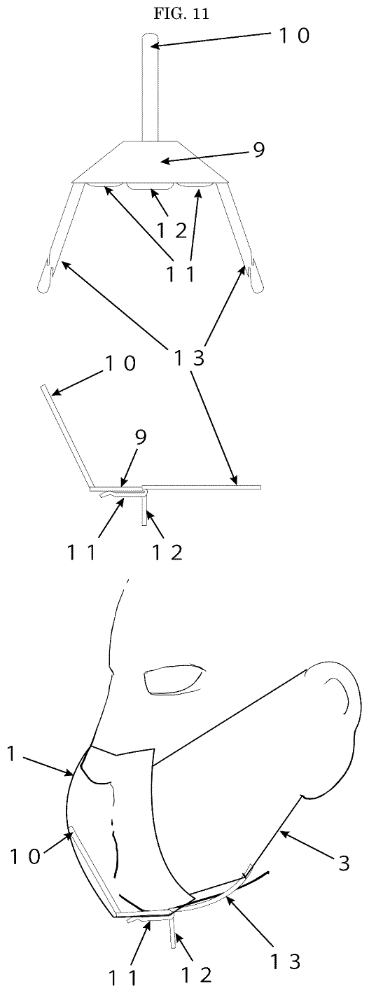

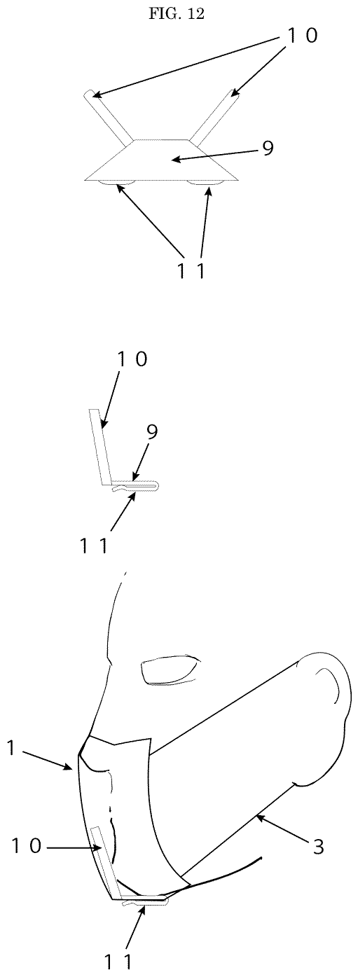

The tension component (10) is attached to the main body (9), is inserted into the inside of the mask (1) and fixed, and is used to secure a space inside the mask (1). Normally, when the mask (1) is worn, a shape of a space around the mouth inside the mask (1) follows the line from the top of the nose to the chin. By using the tension component (10), it is possible to create a space around the mouth, regardless of the line between the nose and the chin. As illustrated in FIG. 2, the tension component (10) may be rod-shaped, or the tension component (10) may be stretched in a frame, as illustrated in FIG. 10. As illustrated in FIG. 11, the tension component (10) may include only one rod to stretch the mask (1) and simply secure a space (7) in front of the face (2). However, in this case, it is not possible to secure a lateral space (8) from the front of the face (2) to cheeks. Therefore, it is preferable to widen the tension component (10), or use a frame tension component (10) as illustrated in FIG. 10, or use a configuration in which the tension component (10) also protrudes in the lateral space (8) from the front of the face (2) to the cheeks, as illustrated in FIGS. 2, 10, and 12. This also has the effect that the clip mask frame of the invention of the present application is less likely to shift in the lateral direction. The main body (9) and the tension component (10) may be connected as an integral structure or in a structure in which the main body (9) and the tension component (10) are removable from each other. In the case of a removable connection, the main body (9) and the tension component (10) may be connected by various methods such as a wire fastener, a hook-and-loop fastener, an attachment including a button and a buttonhole, bolts and nuts, a string connection, and male and female fasteners. However, any method may be used, as long as the tension component (10) does not easily detach from the main body (9) when attached to the main body (9). In the case of a removable connection, a user can rearrange the tension component (10) according to the situation. Further, it is preferable that the angle between the main body (9) and the tension component (10) can be adjusted by bending with a finger or the like. The material of the tension component (10) is preferably a resin such as polypropylene, which is light and flexible, and is not easily affected by sweat or moisture. Moreover, it is preferable to use a material that can be easily cut with scissors or the like. This is because the user can adjust the length and the shape as desired. When manufacturing and using the invention of the present application as a disposable item, paper such as thick paper may be used. The tension component (10) is stretched between the mask (1) and the main body (9), and thus, it is preferable that the tension component (10) has some degree of elasticity. Further, in order to form the tension component (10) integrally with the mask (1), a material having lighter weight is preferable. Therefore, the tension component (10) may be shaped like a lattice or a portion thereof may be cut out.

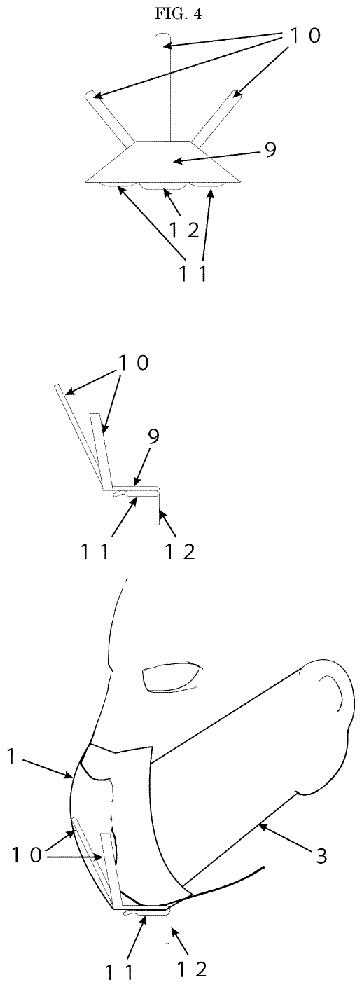

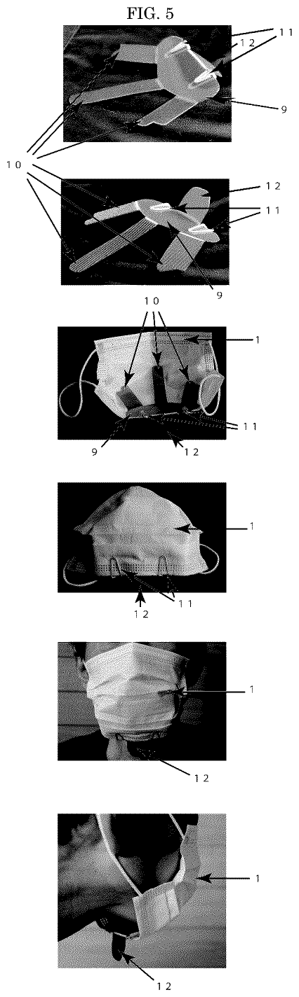

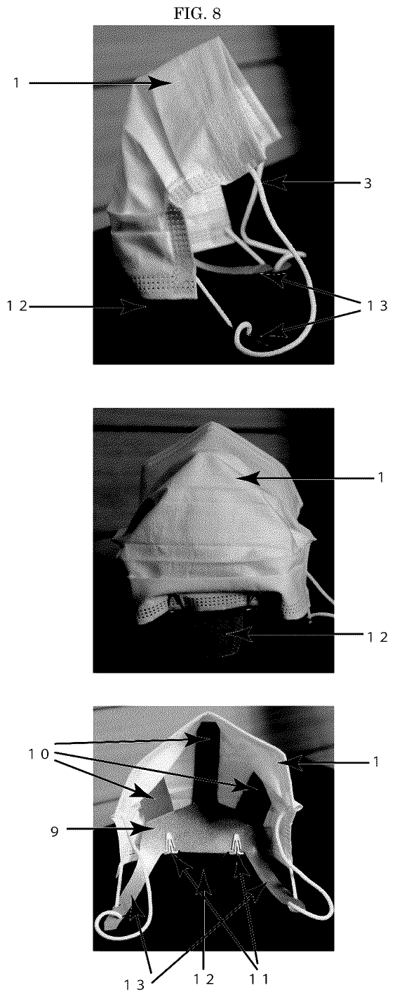

The clip mask frame of the invention of the present application has the general configuration described above, but the handle (12) may also protrude from below the mask (1) in the area of the chin, as illustrated in FIG. 4. This is for adjusting the position of the clip mask frame of the invention of the present application within the mask (1) without touching the mask (1). FIG. 5 is a picture of a prototype. The main body (9) and the handle (12) may be connected as an integral structure or in a structure in which the main body (9) and the handle (12) are removable from each other. In the case of a removable connection, the main body (9) and the handle (12) may be connected by various methods such as a wire fastener, a hook-and-loop fastener, an attachment including a button and a buttonhole, bolts and nuts, a string connection, and male and female fasteners. However, any method may be used, as long as the handle (12) does not easily detach from the main body (9) when attached to the main body (9). It is also possible to fasten the main body (9) and the handle (12) with commercially available clips, hairpins, and the like. It is preferable that the angle between the handle (12) and the main body (9) can be adjusted to some extent by bending the handle (12) with a finger or the like, so that the user can adjust the angle to a desired angle. The material is preferably a resin such as polypropylene, which is light and flexible and is not easily affected by sweat or moisture. Moreover, it is preferable to use a material that can be easily cut with scissors or the like. This is because the user can adjust the length and the shape as desired. When manufacturing and using the invention of the present application as a disposable item, paper such as thick paper may be used. Further, in order to form the handle (12) integrally with the mask (1), a material having lighter weight is preferable. The handle (12) may be shaped like a lattice or a portion thereof may be cut out. When placing emphasis on the function of causing the mask (1) to stand, as illustrated in FIG. 8, which will be described later, it is preferable to widen the handle (12), so that the mask (1) can stand stably.

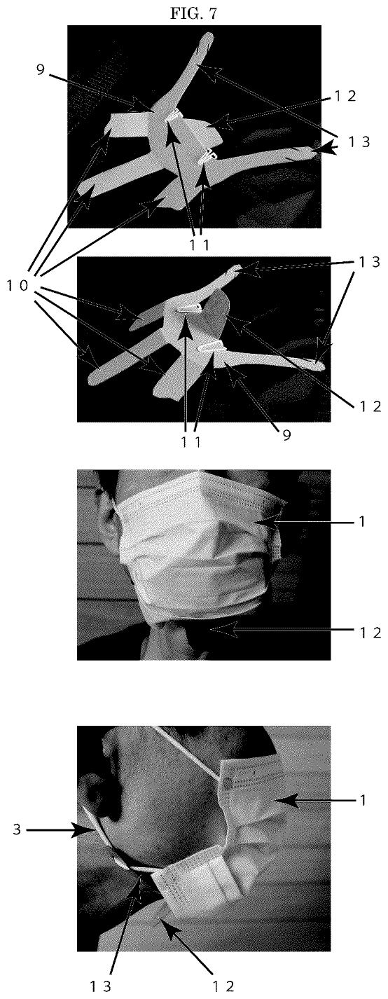

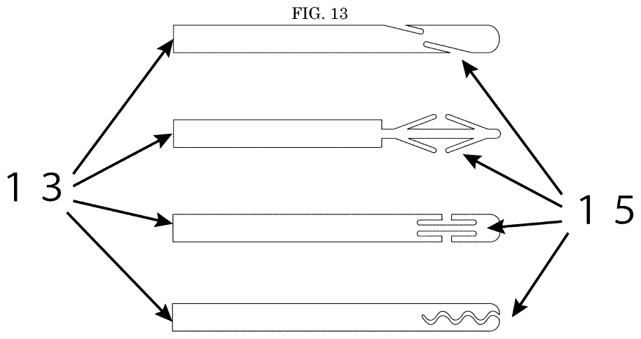

If it is desired to more stably fix the invention of the present application and press the mask (1) more firmly by the tension component (10), each of the arms (13) is attached to the main body (9), as illustrated in FIG. 7, and the side of the arm (13) opposite to the main body (9) is fixed to the side forming the lower side of an ear strap (3) of the mask (1). Thus, the main body (9) is fixed not only to the chin, but also to the ear straps (3), so that the force by which the tension component (10) pushes the mask (1) from the inside is stabilized. The main body (9) and the arms (13) may be integrally formed in advance or may be removable from each other. If the main body (9) and the arms (13) are removable from each other, the main body (9) and the arms (13) may be connected by various methods such as a wire fastener, a hook-and-loop fastener, an attachment including a button and a buttonhole, bolts and nuts, a string connection, and male and female fasteners. However, any method may be used, as long as the arms (13) do not easily detach from the main body (9) when attached to the main body (9). It is also possible to fasten the main body (9) and the arms (13) with commercially available clips, hairpins, and the like. A method of fixing the arms (13) and the ear straps (3) includes a method of winding the ear strap (3) around the tip end of the arm (13), and a method of jointly fastening the ear strap (3) and the arm (13) by a clip, a hairpin, and the like. Any method may be used, as long as the ear strap (3) is fixed to the arm (13) and does not easily detach. FIG. 13 illustrates examples in which a notch (15) is provided in the arm (13) so that the ear strap (3) can be easily wrapped around and fixed to the arm (13). The material of the arms (13) is preferably a resin such as polypropylene, which is light and flexible and is not easily affected by sweat or moisture. When manufacturing and using the invention of the present application as a disposable item, paper such as thick paper may be used. Further, in order to form the arms (13) integrally with the mask (1), a material having lighter weight is preferable. The arms (13) may be shaped like a lattice or a portion thereof may be cut out. When the mask (1) is worn, the arms (13) may touch the cheek and make the user feel uncomfortable. Therefore, the arms (13) are preferably formed of a flexible material and have a structure in which the user can change the angle and the bent state of the arms (13) to some extent.

Further, if the arms (13) are attached together with the above-described handle (12), as illustrated in FIG. 8, the mask (1) does not contact other objects when the mask (1) is not worn and can be caused to stand on a flat surface such as a desk. The mask (1) can stably stand on a flat surface by using three points, that is, the handle (12) and the two arms (13).

The neck strap (14) can also be used in the invention of the present application. In this case, the neck strap (14) is attached to the main body (9) or to the arms (13). A simple string of which the length is adjusted may be used as the neck strap (14) and tied to the main body (9) or the arms (13).

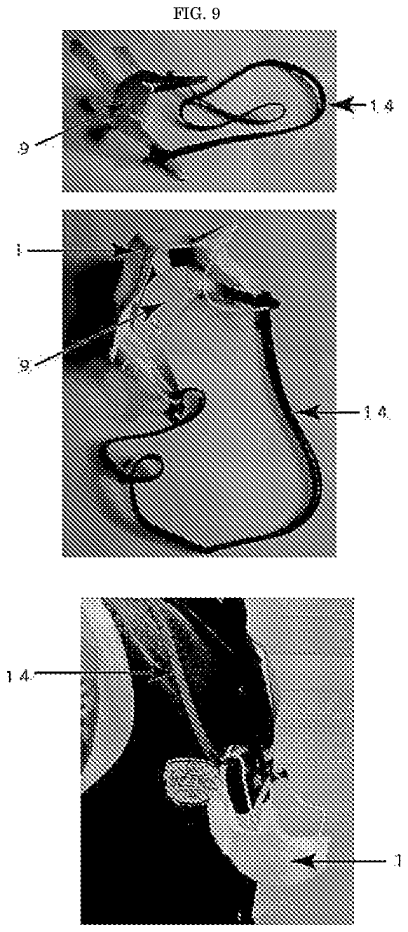

By utilizing the above-mentioned mechanism by which the mask (1) is caused to stand on a flat surface, the mask (1) can be hung from the neck in a hygienic manner. In this case, the neck strap (14) is attached to the main body (9) or to the arms (13). The neck strap (14) may be attached in an integral structure or may be removable. If the neck strap (14) is removable, the main body (9) and the neck strap (14) may be connected by various methods such as a wire fastener, a hook-and-loop fastener, an attachment including a button and a buttonhole, bolts and nuts, a string connection, and male and female fasteners. However, any method may be used, as long as the neck strap (14) does not easily detach from the main body (9) when attached to the main body (9). A simple string of which the length is adjusted may be used as the neck strap (14) and tied to the main body (9) or the arms (13). FIG. 9 illustrates an example in which the neck strap (14) is used. As illustrated in the bottommost picture of FIG. 9, if the mask (1) is shaped so that the mask (1) hangs from the neck and stands on top of clothing, the mask (1) does not contact with the clothing, so that the mask (1) can be hung from the neck in a hygienic manner. Any material may be used, but it is preferable that the material is as light as possible, does not easily break, and is not easily affected by sweat or moisture.

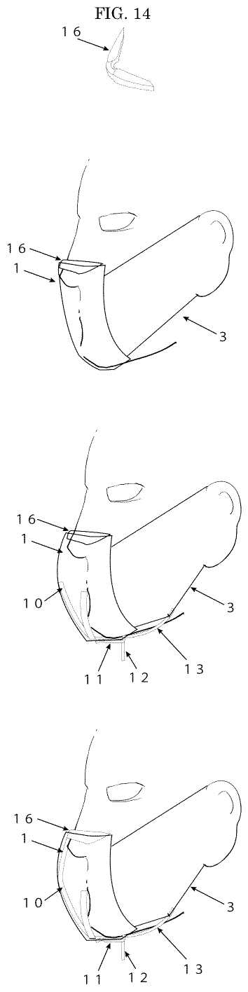

The clip mask frame of the invention of the present application is used as a mask frame and the like, and differs from conventional products in that the clip mask frame is attached from below the mask (1) to secure a space. Therefore, the clip mask frame of the invention of the present application can be easily used simultaneously with other mask frames or assisting tools for the mask (1). As an example, the topmost picture of FIG. 14 illustrates one assisting tool for the commonly available mask (1), and the assisting tool is an item (6) that fills a gap between the nose and the cheeks created when wearing the mask (1) to prevent glasses from fogging. The second picture in FIG. 14 is an image in which the assisting tool is attached. The third picture in FIG. 14 is an example in which the assisting tool is used simultaneously with the invention of the present application. Moreover, the tension component (10) and the like can be extended and connected to these products to form an integral structure. The bottommost picture of FIG. 14 is an image of an integral structure of the mask (1) and the assisting tool (16), which are described as an example here.

The clip mask frame of the invention of the present application is integrally formed with the mask (1), and thus, a material adjusting an oral environment such as an antibacterial agent and a fragrance, or a material having an effect such as a relaxing effect may be coated onto the clip mask frame.

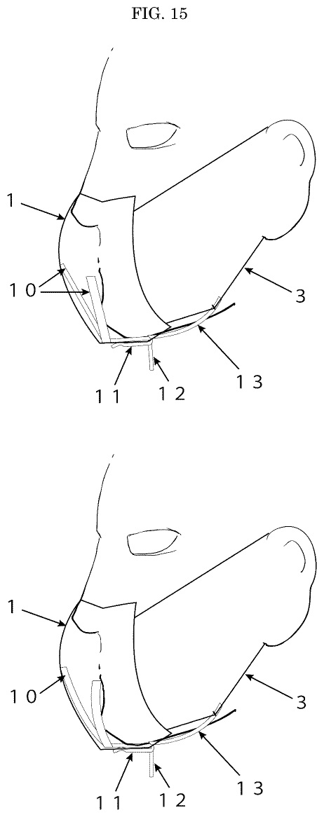

A method of using the clip mask frame will be described below. The clip mask frame of the invention of the present application can be attached to a general mask (1) in which the lower part of the mask (1) wraps around under the chin when the mask (1) is worn. An example of the general mask (1) is a general nonwoven mask (1). First, as illustrated in FIG. 3, the clip (11) of the clip mask frame of the invention of the present application is inserted into the lower part of the mask (1) and firmly held. The tension component (10) of the clip mask frame of the invention of the present application is placed inside the mask (1), and the angle is adjusted. When the mouth is opened and closed during a conversation and the like, the mask (1) is also pulled up and down. As illustrated in the lower drawing of FIG. 15, it is preferable that the tension component (10) is slightly warped within the mask (1) and attached so as not to be affected, even if the mask (1) is pulled up and down to some extent. Moreover, if the tension component (10) is removable, different types thereof can be used according to the situation. If the length or the shape of the tension component (10) is not convenient, the user may adjust the tension component (10) by using scissors or the like.

Therefore, the clip mask frame of the invention of the present application can be integrally formed with the mask (1) and can be attached to the face (2). The clip mask frame of the invention of the present application is attached so as to fit to a lower portion of the chin and a lower part of the mask (1).

As illustrated in FIGS. 4 and 5, by using the handle (12), it is possible to adjust a position of the clip mask frame of the invention of the present application within the mask (1), without touching or removing the mask (1) when wearing the clip mask frame of the invention of the present application. The handle (12) is attached to the main body (9) of the clip mask frame of the invention of the present application, and protrudes from the lower part of the mask (1), that is, from an area below the chin, when the clip mask frame of the invention of the present application is attached to the mask (1). The handle (12) can be operated to adjust the position. Further, if the handle (12) is removable, different types thereof can be used according to the situation. If the length or the shape of the handle (12) is not convenient, the user may adjust the handle (12) by cutting.

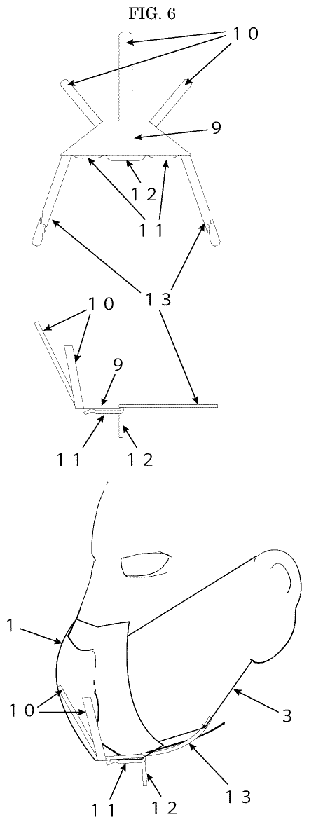

As illustrated in FIGS. 6 and 7, when the arms (13) are used, the invention of the present application is fixed not only to the chin, but also to the ear straps (3), so that the tension component (10) can more stably push the mask (1). When the arms (13) are used as the ear straps (3) of the mask (1) are attached to the face (2), the notch portion (15) of each of the arms (13) is hooked to a portion below the ears. By connecting the clip mask frame of the invention of the present application and the ear straps (3) of the mask (1), the force fixing the clip mask frame of the invention of the present application increases, and as a result, the tension component (10) can push the mask (1) strongly from inside.

By using both the handle (12) and the arms (13), the mask (1) can be cause to stand on a flat surface such as a desk. The expression “caused to stand” means that the clip mask frame of the invention of the present application can be placed in an upright state, similar to the state of the mask (1) when attached to the face (2). This is convenient when the mask (1) is temporarily removed, such as during eating. When the mask (1) is removed, if the mask (1) is placed on a desk or the like in an upright state with the clip mask frame portion of the invention of the present application on a lower side, the mask (1) stands in a state illustrated in FIG. 8. The clip mask frame of the invention of the present application can be stably placed on a flat surface at three points: the handle (12) and the arms (13). The mask (1) does contact the flat surface on which the clip mask frame is placed. In this state, the mask (1) can be easily exposed to ultraviolet light to be sterilized, and the mask (1) can be easily dried or sprayed with a disinfectant.

The neck strap (14) is not generally used with the mask (1). This is because, if the neck strap (14) is used with the mask (1), the mask (1) contacts clothing when the mask (1) is hanging from the neck, so that bacteria may stick to the mask (1), which is unsanitary. As will be described later, the invention of the present application is designed so that the mask (1) can be hung from the neck in a hygienic manner. This is considered to be useful in cases such as when the mask (1) is temporarily removed during eating. If it is desired to use the neck strap (14) to hang the mask (1) from the neck, the neck strap (14) is attached to the main body (9) or the arms (13), or a string having an appropriate length is used as the neck strap (14) and wound around the main body (9) or the arms (13).

At this time, if both the handle (12) and the arms (13) are used, the clip mask frame portion of the invention of the present application can be turned toward the clothing when the mask (1) is removed, so that the mask (1) can be placed on the surface of the clothing, as illustrated in the bottommost picture of FIG. 9. The outer surface and the inner surface of the mask (1) do not stick to other parts such as a desk or clothing, so that the mask (1) can be placed in a clean manner. This is convenient when the mask (1) is temporarily removed, such as during eating. If the handle (12) is widened, the feeling of security increases.

Note that the clip mask frame of the invention of the present application is not limited to the embodiments described above, and various modifications can be made based on the gist of the clip mask frame of the invention of the present application, and these modifications are also included in the scope of the clip mask frame of the invention of the present application.

### REFERENCE SIGNS LIST

1 . . . Mask (1)
2 . . . Face (2)
3 . . . Ear strap (3)
4 . . . Mask frame of Patent Document 1
5 . . . Mask frame of Non-Patent Document 1
6 . . . Mask frame in clip mask frame of invention of present application
7 . . . Space in front direction of face (2) inside mask (1)
8 . . . Space in lateral portion from front of face (2) to cheeks inside mask (1)
9 . . . Main body (9) of mask frame in clip mask frame of invention of present application
10 . . . Tension component (10) of mask frame in clip mask frame of invention of present application
11 . . . Clip (11) of mask frame in clip mask frame of invention of present application
12 . . . Handle (12) of mask frame in clip mask frame of invention of present application
13 . . . Arm (13) of mask frame in clip mask frame of invention of present application
14 . . . Neck strap (14) of mask frame in clip mask frame of invention of present application
15 . . . Notch for fastening ear strap (3) and arm (13)
16 . . . Commercially available mask assisting tool to prevent fogging of glasses

1. A mask frame of a type that, when attached to a mask (1), creates a space between the mask (1) and a face (2) to facilitate breathing, the mask frame being wearable with a mask (1) of a general type in which a lower part of the mask (1) wraps around below a chin when the mask (1) is worn, the mask frame being integrally formed with the lower part of the mask (1), the mask frame comprising:
a main body (9) entering an area below the chin;
a tension component (10) having a rod shape and protruding toward a front direction of the main body (9) to push the mask (1) from inside and secure a space inside the mask (1); and
a clip (11) for attaching the present mask frame to the lower part of the mask (1),
wherein the tension component (10) having the rod shape may be integrally formed with the main body (9) or may be removable and replaceable with a tension component having various shapes and sizes,
the clip (11) may also be integrally formed with the main body (9), or may not be integrally formed with the main body (9), and the mask (1) and the main body (9) may be held by using another pinching device such as a general clip and a hairpin, if the clip (11) is integrally formed with the main body (9), the clip (11) is positioned below the main body (9), and
when the present mask frame is worn, the main body (9) is fixed to the lower part of the mask (1) by the clip (11) and forms an integral structure with the mask (1), and the tension component (10) pushes and spreads the mask (1) from inside the mask (1) not only in a front direction of a face, but also in various directions such as a lateral front direction, so that a space created between the mask (1) and a face (2) is larger than in a conventional mask frame.

2. The mask frame of claim 1, wherein the tension component (10) has not only the rod shape in the front direction when viewed from the main body (9), but continues also in a lateral direction to form a frame and secure a space inside the mask (1) as a whole.

3. The mask frame of claim 1, wherein an assisting tool (16) for preventing glasses from fogging is attached to a tip end of the tension component (10), the assisting tool (16) being simultaneously usable in an integral structure with the tension component (10).

4. The mask frame of claim 1, wherein the main body (9) is fixed to the mask (1) by using, instead of the clip (11), a hook formed integrally with or separately from the main body, or male and female fasteners, a sticker, and an adhesive.

5. The mask frame of claim 4, wherein a handle (12) for manually adjusting a position of the present mask frame and the mask (1) without touching the mask (1) can be attached to the main body (9), the handle (12) protruding from below the chin at the lower part of the mask (1) when the present mask frame is worn, the handle (12) may be integrally formed with the main body (9), or may be removable and replaceable with a handle having various shapes and sizes, and by using the handle (12) simultaneously with arms (13), the mask (1) can be caused to stand on a flat surface at three points including the handle (12) and the arms (13), when the mask (1) is not worn.

6. The mask frame of claim 5, wherein, if the present mask frame is to be fixed not only to the lower part of the mask (1), but also to ear straps (3) to stabilize the tension component (10), and the mask (1) is to be pressed more firmly, the arms (13) can be attached, the arms (13) each being formed by a component having a shape extending from a side surface and from a rear side of the main body (9) along a side surface of the face, and a shape extending in a direction downward from an ear, each of the arms (13) being fixed to a lower side of a corresponding one of the ear straps (3) of the mask (1) by winding the ear strap (3) around the arm (13) or fixing the arm (13) with a fixing device such as a clip, the arms (13) may be integrally formed with the main body (9) or may be removable and replaceable with an arm having various shapes and sizes, and by using the arms (13) simultaneously with the handle (12) of claim 5, the mask (1) can be caused to stand on a flat surface at three points including the handle (12) and the arms (13) when the mask (1) is not worn.

7. The mask frame of claim 6, wherein, if a neck strap (14) is to be used to hang the mask (1) from a neck, the neck strap (14) may be attached to the arms (13) or the main body (9), and the neck strap (14) may be integrally formed with the arms (13) or the main body (9) or may be removable and replaceable with a neck strap having various shapes and sizes, further, a simple string may be tied to the arms (13) or the main body (9) and used as the neck strap (14), and if the mask (1) is not to touch clothing when the mask (1) is removed while using the neck strap (14), both the handle (12) and the arms (13) are combinedly used, so that the mask (1) can be hung from the strap (14) so as to substantially stand on the clothing and contact the clothing only at three points including the handle (12) and the arms (13).

8. The mask frame of claim 1, wherein a material adjusting an oral environment such as an antibacterial agent and a fragrance, or a material having an effect such as a relaxing effect is coated onto the mask frame, or a material having such an effect is attached to the mask frame.

9. The mask frame of claim 1 being used as a disposable mask frame by employing a less expensive material, or alternatively, by employing a material such as thick paper not having a negative impact on the environment when being thrown away as garbage.

10. The mask frame of claim 1, wherein a user may use scissors or the like to change a length or adjust a shape of the tension component (10) and the handle (12), or may bend the tension component (10) and the handle (12) with a finger to adjust the shape.
